(19) United States
(12) Patent Application Publication
(10) Pub. No.: US 2024/0262233 A1
(43) Pub. Date: Aug. 8, 2024

(54) METHODS FOR CONTROLLING OPERATION OF ELECTRIC VEHICLE CHARGING STATIONS

(71) Applicant: ADDÉNERGIE TECHNOLOGIES INC., Québec City (CA)

(72) Inventors: Louis-Philippe PERRON-HOULE, Québec City (CA); Simon DUGRÉ, Québec City (CA); Léonard GAGNON, Québec City (CA)

(73) Assignee: ADDÉNERGIE TECHNOLOGIES INC., Québec City, QC (CA)

(21) Appl. No.: 18/463,381

(22) Filed: Sep. 8, 2023

Related U.S. Application Data
(60) Provisional application No. 63/483,436, filed on Feb. 6, 2023.

(51) Int. Cl. B60L 53/60; B60L 53/31

(52) U.S. Cl. CPC B60L 53/60; B60L 53/31; B60L 2250/22

(57) ABSTRACT

An electric vehicle charging station is disclosed. The electric vehicle charging station includes a housing, a motion sensor mounted within the housing, and a processor communicably coupled to the motion sensor. The processor is configured to: obtain sensor output of the motion sensor; detect a first motion of the housing based on the obtained sensor output; and in response to detecting the first motion, initiate an auxiliary operation for activating a first safety feature corresponding to the detected first motion in connection with the electric vehicle charging station.

### CROSS-REFERENCE TO RELATED APPLICATIONS

This application claims the benefit of priority to U.S. Provisional Patent Application No. 63/483,436 filed on Feb. 6, 2023, the contents of which are incorporated herein by reference.

### TECHNICAL FIELD

This application relates to electric vehicles and, more particularly, to methods for controlling operation of electric vehicle charging stations.

### BACKGROUND

An electric vehicle (EV) charging station is an element of infrastructure that supplies electrical power for charging plug-in electric vehicles, such as electric cars, trucks, buses, and plug-in hybrids. EV charging stations are sometimes provided on-street or in areas near vehicular and pedestrian traffic. The term “electric vehicle charging stations”, as used herein, may include both Level 2 and Level 3 EV charging stations. Some electric vehicle charging stations may be or include electric vehicle supply equipment (EVSE) that cooperates with on-vehicle charging equipment.

Upon impact by a vehicle or under stress from another force in the environment, an EV charging station may physically break or become damaged. In order to prevent such damage, a protective element such as a bollard may be installed near an EV charging station. In some situations, use of a bollard or other means of physically shielding an EV charging station from accidental vehicle collisions may not be feasible or sufficient. Without such physical shielding or if such shielding is insufficient, a charging station may collapse upon impact. This, in turn, may present a considerable threat to nearby pedestrians or other vehicles, due to the potential for physical collisions and damage to the electric wiring within the station. Exposed, or otherwise damaged, electric wiring may lead to hazards such as fires and electrocution.

### BRIEF DESCRIPTION OF THE DRAWINGS

Reference will now be made, by way of example, to the accompanying drawings which show example implementations of the present application and in which:

FIG. 1 is a perspective view of an example implementation of an electric vehicle (EV) charging station;

FIG. 2 is a perspective view of another example implementation of an EV charging station;

FIG. 3A is a top plan view of an EV charging station that is configured for pull-up charging;

FIG. 3B is a top plan view of an EV charging station that is configured for pull-through charging;

FIG. 4 is a side view of an example EV charging station adjacent to a vehicle;

FIG. 5 is a side view of an example EV charging station and a vehicle after impact;

FIG. 6 shows, in flowchart form, an example method for operating an EV charging station;

FIG. 7 shows, in flowchart form, another example method for operating an EV charging station; and

FIG. 8 shows, in flowchart form, another example method for operating an EV charging station;

FIG. 9 shows, in flowchart form, another example method for operating an EV charging station; and

FIG. 10 is a high-level schematic diagram of an example EV charging station.

Like reference numerals are used in the drawings to denote like elements and features.

### DETAILED DESCRIPTION OF EXAMPLE IMPLEMENTATIONS

The popularity of electric vehicles has given rise to the establishment of a growing number of curbside EV charging stations or stations otherwise located near vehicular and/or pedestrian traffic. While curbside EV charging stations bring convenience to drivers, they also present certain hazards to pedestrians. To ensure safety of pedestrians, an EV charging station may be designed to withstand low-speed impact by vehicles, such as may be associated with an accidental impact during parking. At the same time, an EV charging station may be designed to fall safely during a high-speed impact. An EV charging station may for example, be designed to fall towards the point of impact (i.e., onto the vehicle) rather than away from the vehicle where there may be pedestrians or other vehicles. Upon impact or detected damage, an EV charging station may be designed to automatically de-energize to reduce the risk of electrocution to pedestrians or vehicle occupants.

In the absence of continuous active monitoring by an operator, it is generally challenging to determine when an EV charging station has been damaged or is in such a physical state so as to pose a potential threat to safety. If an EV charging station is physically affected by external forces (e.g., a colliding vehicle, extreme winds, etc.) that result in changes to the physical state of the EV charging station, the ability to detect such changes without visual inspection of the equipment may be limited. For example, a vehicle may accidentally be driven into an EV charging bollard, causing it to become tipped or tilted. As another example, a user may forget to disconnect (or incorrectly disconnect) a cable from the vehicle inlet before driving away from the EV charging station. As a consequence, the vehicle may exert a pulling force on the cable, causing the EV charging station to tip or tilt.

Continued normal operation of an affected EV charging station may lead to various problems. A tipped EV charging bollard may be an electrical safety hazard as the tipping motion may expose an electrical contact that is not intended to be exposed, or since the compromised architecture of the EV charging station may cause other electrocution risks. Furthermore, even a partially tipped EV charging bollard may present a danger to nearby pedestrians or vehicles due to the possibility of inadvertent collision or further tipping and landing.

The present application discloses solutions for automatically detecting changes to the physical state of EV charging stations. Specifically, a system and methods for determining whether a stationary EV charging station has tipped, tilted, or otherwise undergone motion (e.g., rotational, linear, etc.) are proposed. In response to detecting such changes, certain safety operations may be initiated to ensure that suitable actions are taken to remedy hazards associated with one or more EV charging stations.

In an aspect, the present disclosure describes an electric vehicle charging station. The electric vehicle charging station includes a housing, a motion sensor mounted within the housing, and a processor communicably coupled to the motion sensor. The processor is configured to: obtain sensor output of the motion sensor; detect a first motion of the housing based on the obtained sensor output; and in response to detecting the first motion, initiate an auxiliary operation for activating a first safety feature corresponding to the detected first motion in connection with the electric vehicle charging station.

In some implementations, the housing may comprise a bollard assembly.

In some implementations, the motion sensor may comprise at least one of: an accelerometer; a gyroscope; or a tilt indicator.

In some implementations, detecting the first motion of the housing may include determining that a tilt of at least a portion of the housing has occurred.

In some implementations the electric vehicle charging station may further include an electric vehicle charger unit including at least one power converter module, and initiating the auxiliary operation for activating a first safety feature may include controlling operation of an auxiliary component that is different from the electric vehicle charger unit.

In some implementations, initiating the auxiliary operation for activating a first safety feature may include triggering a camera system to capture image data depicting at least a portion of an area surrounding the housing.

In some implementations, the camera system may include one or more image sensors that are disposed on the housing.

In some implementations, the camera system may include one or more image sensors that are disposed externally of the housing and oriented toward an area surrounding the housing.

In some implementations initiating the auxiliary operation for activating a first safety feature may include causing charging operations of at least one neighbouring electric vehicle charging station to be disabled.

In some implementations, at least a portion of the motion sensor may be disposed vertically above a threshold height of the housing.

In some implementations, the processor may be further configured to determine that at least a portion of the housing that is vertically above the threshold height undergoes the first motion.

In some implementations, the processor may be further configured to identify the first safety feature based on a mapping between one or more detectable motions of the housing and one or more defined safety operations associated with the electric vehicle charging station.

In some implementations, detecting the first motion of the housing may include determining a tilt angle of the housing.

In some implementations, initiating the auxiliary operation for activating a first safety feature may include causing a visual indicator of an operational status of the electric vehicle charging station to be changed.

In another aspect, the present disclosure describes a processor-implemented method. The method includes: obtaining sensor output of a motion sensor mounted within a housing of an electric vehicle charging station; detecting a first motion of the housing based on the obtained sensor output; and in response to detecting the first motion, initiating an auxiliary operation for activating a defined safety feature corresponding to the detected first motion in connection with the electric vehicle charging station.

In another aspect, the present disclosure describes a non-transitory, computer-readable storage medium. The instructions, when executed by a processor, are to cause the processor to: obtain sensor output of the motion sensor; detect a first motion of the housing based on the obtained sensor output; and in response to detecting the first motion, initiate an auxiliary operation for activating a defined safety feature corresponding to the detected first motion in connection with the electric vehicle charging station.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

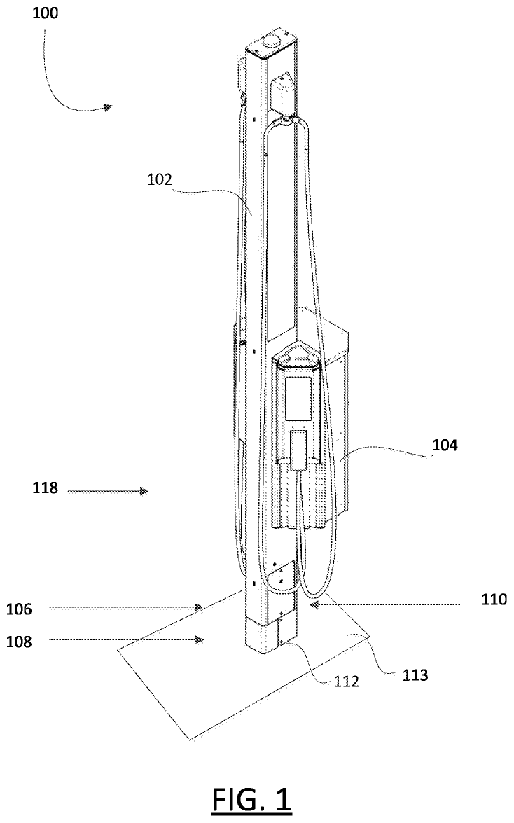

Reference is first made to FIG. 1, which illustrates a perspective view of an example EV charging station 100. The EV charging station 100 includes a vertical post structure, such as a charger post 102, and one or more EV chargers 104 that are mounted to the post structure. The charger post 102 is supported by a curbside base 112. In at least some implementations, the post structure may be formed as a bollard assembly. The bollard assembly may comprise a sealed enclosure or housing that integrates one or more EV charger units therein. In particular, the bollard assembly may include components of EV charger units such as, among others, a battery system, power converters (e.g., AC-to-DC converters), a charge controller, and cables and connectors. The EV charger unit components may be fixedly secured to the bollard assembly. Specifically, the locations of the EV charger unit components within the bollard assembly may be fixed.

The application of external forces, such as a collision by a vehicle, may result in the EV charging station 100 physically breaking or becoming damaged. The EV charging station 100 may be designed to include a failure point that allows the EV charging station to break away from a base (or base section) upon impact by a sufficiently large force. An interface section 110 of the charger post 102 may include an electrical break-away section 106 and a mechanical break-away section 108. The interface section 110 is located between the one or more EV chargers 104 and a curbside base 112 (which may also be referred to as a groundside base, base, or base section). The curbside base 112 may in some implementations, be entirely or partially buried. That is, the curbside base 112 may be installed in or under ground 113. The curbside base 112 may for example, be installed in concrete or asphalt. Since the curbside base 112 is illustrated in FIG. 1 as being at least partially buried, the curbside base 112 is not entirely visible in FIG. 1. The charger post 102 is securely mounted on the curbside base 112. The curbside base 112 may for example, be a concrete foundation.

The electrical break-away section 106 is designed to be engaged when the mechanical break-away section 108 is activated. The electrical break-away section 106 is arranged to ensure electrical disconnection of the one or more EV chargers 104 when a mechanical break-away section 108 breaks apart. That is, the breaking of the mechanical break-away section 108 may cause the electrical break-away section 106 to break the electrical connection with the affected EV charger(s).

The mechanical break-away section 108 connects a base section, such as the curbside base 112, with a charger section that includes the EV charger(s) 104. The mechanical break-away section 108 facilitates a controlled breaking of the EV charger(s) 104. In particular, the mechanical break-away section 108 may be configured such that the breaking at the mechanical break-away section 108 causes automatic disconnection of the electrical break-away coupling(s) in the electrical break-away section 106. The mechanical break-away section 108 may include one or more mechanical break-away couplings that are designed to withstand low-impact speeds but will fail at speeds exceeding a defined threshold. The mechanical break-away couplings allow for controlling the direction of fall of the EV charging station. These components may ensure, for example, that the EV charging station 100 falls on top of a vehicle upon impact rather than away from the vehicle.

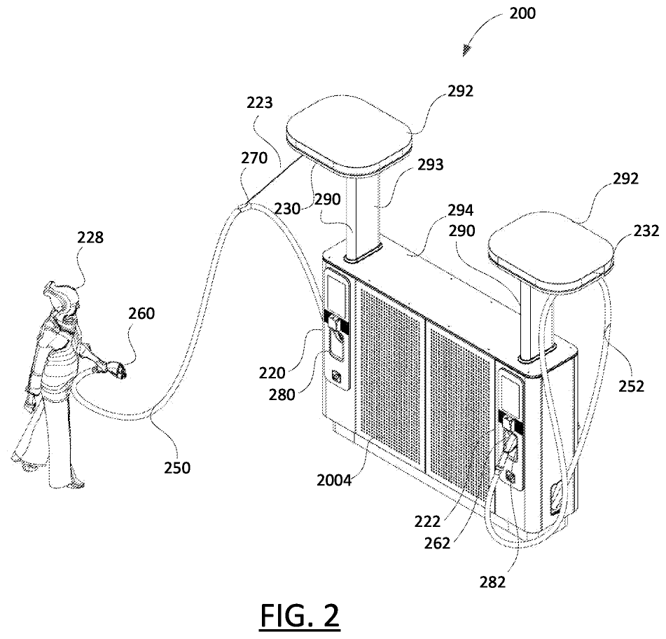

Reference is now made to FIG. 2, which illustrates another example EV charging station 200 in a perspective view. The EV charging station 200 includes two EV chargers 220 and 222. In other implementations, the EV charging station 200 may include a greater or lesser number of EV chargers than the EV charging station 200.

Each of the EV chargers 220, 222 may allow the EV charging station 200 to concurrently charge a separate electric vehicle. For example, an EV charging station 200 having two EV chargers may concurrently charge two electric vehicles, an EV charging station 200 having three EV chargers may concurrently charge three EVs, and so on. The EV chargers may be of various types including, for example, any one or more of Level 1 chargers, Level 2 chargers, Level 3 chargers, DC Fast chargers (DCFC), Level 4 chargers, etc. In some implementations, the EV charging station 200 may include an EV charger that charges an EV at 400 volts or more.

An operator 228 may use the EV charging station 200 to charge an electric vehicle by extending one of the charging cables 250, 252 until one of the connectors 260, 262 can be aligned with the charging port of the electric vehicle. The operator 228 can then plug the connectors 260, 262 into the charging port and the EV charging station 200 can initiate charging of a battery of the electric vehicle.

The EV charging station 200 includes one or more enclosures 293. The enclosure 293 may include multiple parts. As shown in FIG. 2, the enclosure 293 may include a support 290, an upper housing 292, and a lower housing 294. The support 290 may be a columnar support. The support 290 may house one or more components of the EV charging station 200 such as one or more electrical wires providing power and/or communications to components housed within the upper housing 292. In some implementations, one or more such electrical wires may provide communications between components housed within the upper housing 292 and components housed within the lower housing 294.

The support 290 may support the upper housing 292 so that the upper housing 292 remains fixed relative to one or both of the support 290 and the lower housing 294. The support 290 may hold the upper housing 292 in a generally horizontal orientation so that the upper housing 292 acts as a canopy or shade. The upper housing 292 may house a cable management system which may be used to facilitate retraction or extension of the charging cables 250, 252. As shown in FIG. 2, the cable management system may be configured to retract and extend a mechanical wire 223 that is connected to a charging cable 250 via a coupler 270. The cable management system or a portion thereof may be located in other regions including, for example, the support 290.

The upper housing 292 may include one or more lights such as, for example, light-emitting diode (LED) lights. Each light may be associated with (e.g., connected to) a particular one of the EV chargers and may be controlled to indicate a status of the associated EV charger. The light may be controlled to indicate a condition of an associated EV charger such as: charge status, availability of the charger, physical state (e.g., damaged, tiled, etc.) of the charger, state of one or more neighbouring EV chargers, requirement for maintenance, etc. In at least some implementations, different lighting schemes may be used to communicate different conditions of the EV chargers. For example, color may be used to distinguish between different charge statuses. A first lighting color may represent a first status and a second lighting color may represent a second status. The lights of the EV charging station 200 may be referred to as lighting canopies 230, 232.

In the illustrated example, each of the EV chargers 220, 222 has a separate lighting canopy 230, 232 associated with that EV charger. Each of the lighting canopies may be separately controlled. In this way, an operator may easily identify the status of each of the EV chargers 220, 222, even though the EV chargers are coupled to one another. Put differently, separate lighting canopies may be provided to separately identify the status of each EV charger when the EV chargers are provided in a monolithic form in which the EV chargers are coupled to one another.

As shown in FIG. 2, each lighting canopy 230, 232 includes at least one wrap-around light. The wrap-around light may wrap around the complete perimeter of the lighting canopy. The status of the associated EV charger may be easily identified by an operator from any side of the EV charger 220, 222. The wrap-around lights may wrap around a perimeter that is on a horizontal plane or a substantially horizontal plane.

Each of the lighting canopies 230, 232 is a separate and distinct component of the EV charging station 200. A first lighting canopy 230 is mounted above the first EV charger 220 and a second lighting canopy 232 is mounted above the second EV charger 222. Conveniently, in this way, the status of each of the EV chargers 220, 222 may be easy for operators to identify. Additionally, or alternatively, the separate lighting canopies 230, 232 may highlight to operators that it is possible to charge a second electric vehicle at the EV charging station 200 even if the EV charging station 200 is already in use by a first electric vehicle. In at least some implementations, the number of lighting canopies 230, 232 corresponds to the number of EV chargers 220, 222 included in the monolithic EV charging station 200. For example, two lighting canopies 230, 232 are present in the illustrated EV charging station 200 since there are two EV chargers 220, 222.

In the illustrated example of FIG. 2, the lower housing 294 is substantially a rectangular prism. The lower housing 294 includes both the first EV charger 220, the second EV charger 222, and a power cabinet 2004.

The power cabinet 2004 houses and includes power conversion and supply circuitry, such as power modules. The power cabinet 2004 may house and include components of the EV charging station 200 that would typically be, in a distributed architecture, located in a separate and remotely positioned power cabinet. The power cabinet 2004 may be referred to as one or more of: a power bank, a power engine, a power block, a power unit, a power system.

The EV chargers 220, 222 do not include power modules and power conversion and supply circuitry. Rather, the EV chargers 220, 222 in the illustrated example are dispensers which simply dispense the supplied power from the power modules to an electric vehicle which connects via one of the charging cables 250, 252. The reference to the EV chargers 220, 222 may be replaced with a reference to “dispensers”. The EV chargers 220, 222 are located at the sides of the EV charging station 200, and the power cabinet 2004 is disposed between the EV chargers 220, 222. The location of the power cabinet 2004 between the two EV chargers 220, 222 may provide certain benefits. For example, it may be that the EV chargers 220, 222 provide a buffer or crunch zone so that any impact to the EV chargers 220, 222 from certain sides is less likely to result in damage to the sensitive and expensive components housed in the power cabinet 2004. Further, in at least some deployments, the sandwiched power cabinet infrastructure may result in a need for fewer safety bollards and/or real estate, particularly when compared with a distributed system.

The EV charging station 200 may be configured as either a pull-up or pull-through orientation. In some implementations, a substantially common unit may be used in both pull-up and pull-through deployments, which may reduce manufacturing costs.

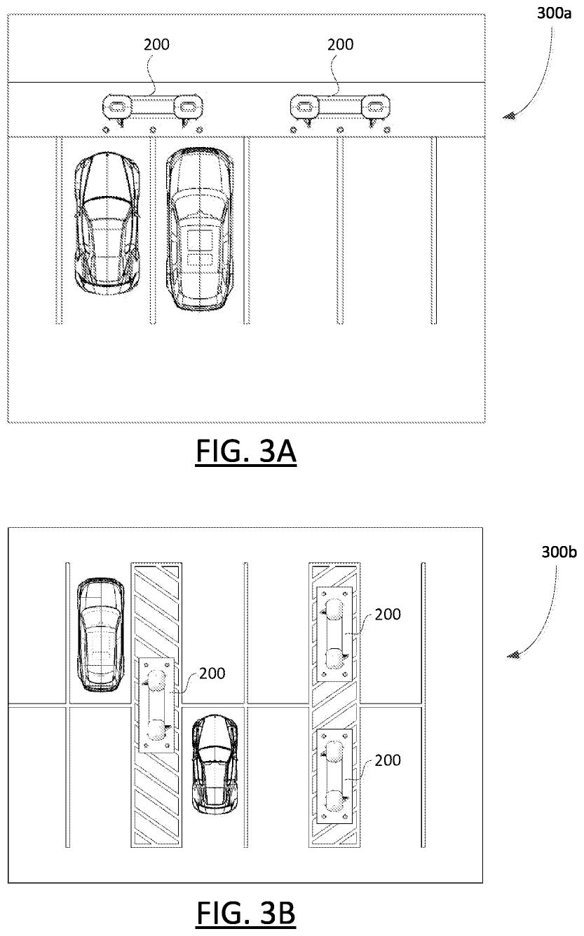

A pull-up deployment 300a is illustrated with reference to FIG. 3A. The pull-up deployment 300a is a deployment commonly used in a parking lot. In the pull-up deployment, a front of a vehicle (or a rear of the vehicle as the case may be) is oriented to face an EV charging station 200. Parking spaces may be provided in front of (i.e., at a front side of) the EV charging station 200. In this configuration, both EV chargers 220, 222 may be on a same side. For example, both EV chargers 220, 222 may be located on a front side of the EV charging station 200. Each EV charger has its own customer equipment, such as a connector 260, 262, holster 280, 282 and interface (such as a display screen) and, in the pull-up deployment 300a, the customer equipment is all located on one side.

FIG. 3B illustrates a pull-through deployment 300b for the EV charging station 200. The pull-through deployment 300b is one in which cars pull up to the EV charging station 200 by driving alongside the EV charging station 200. That is, a vehicle may drive in and park parallel to the EV charging station 200; for example, parallel to a front side and/or rear side of the EV charging station 200.

The pull-through deployment 300b may offer one or more advantages. This type of deployment may be useful, for example, when retrofitting a gas station with EV charging stations 200. This type of deployment may also, if desired, be used in some parking lots. This type of deployment may allow for easier access for vehicles having trailers such as recreational vehicle (RV) trailers and campers, other RVs, and other large vehicles such as semi trucks, farm machinery and tractor trailers.

As illustrated, the pull-through deployment 300b may include EV charging stations 200 having EV chargers 220, 222 on opposing sides. For example, a first EV charger 220 may be on a front side and a second EV charger 222 may be on a rear side. In this way, a vehicle may be charged on each of the sides by pulling up next to the EV charging station 200.

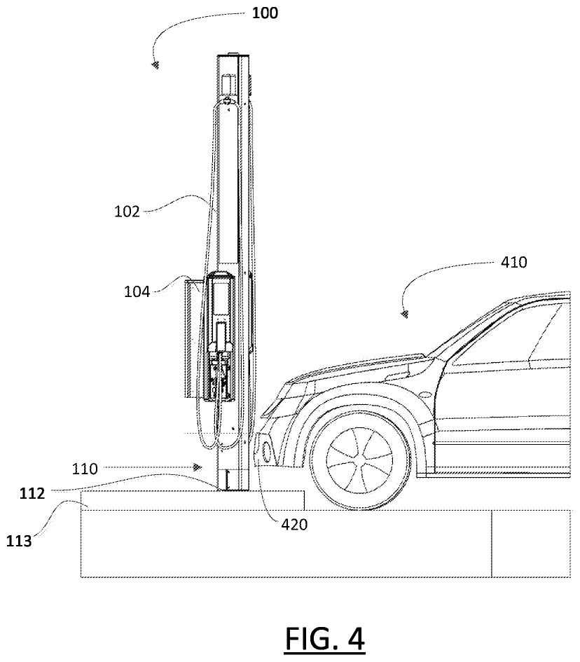

Reference is now made to FIG. 4, which illustrates a side view of an EV charging station 100 adjacent to a vehicle 410, in accordance with an example implementation of the present application. In FIG. 4, the charger post 102 is positioned such that the interface section 110 aligns with a potential “point of impact” of vehicle bumper 420. The interface section 110 may thus be located at a point that enables mechanical and electrical break-away upon impact by a vehicle 410. In some implementations, the design location of the interface section 110 may be determined by subtracting the height of the sidewalk from a bumper height. For example, an average passenger vehicle bumper height may be 24 inches and the height of a sidewalk from a road may be 6 inches. In such an example, the interface section 110 may be positioned at 18 inches above the base of the charger post.

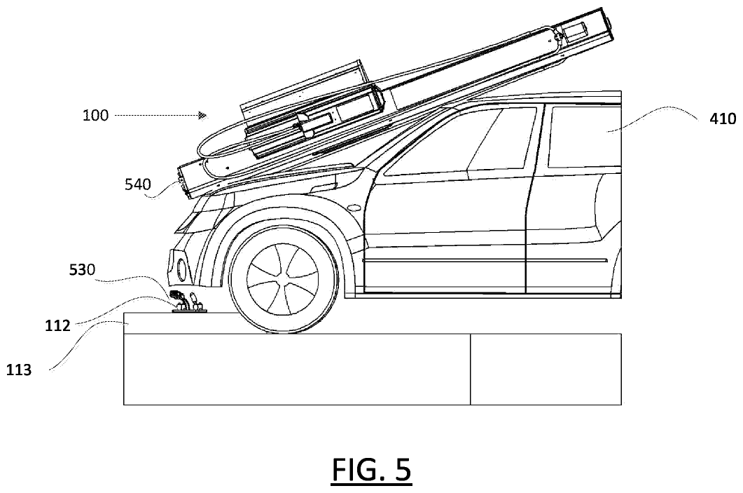

FIG. 5 shows an EV charging station 100 after a high-speed impact with a vehicle 410. The mechanical break-away couplings failed, resulting in safe disconnection of the electrical break-away coupling and the physical breaking of EV charging station 100 around the point of impact. The EV charging station 100 rests upon the vehicle 410, having fallen in a direction that corresponds to the side of the impact. EV charging station interface section remnant 530 remains attached to the curbside base 112.

It may be seen that, by configuring the mechanical break away couplings to cause the EV charging station to fall upon the vehicle, an end 540 that was previously coupled to the curbside base 112 through the mechanical break-away couplings is raised upward. Specifically, impact by the vehicle 410 causes the broken-away EV charging station to fall upon the vehicle 410, creating a pivoting effect where the end 540 is raised. This, in turn, causes electrical connectors of the electrical break-away coupling to disconnect from one another.

While a complete break causing electrical and/or mechanical break-away of the EV charging station is a good indication of damage to the EV charging station, other types of damage may be subtle and more challenging to detect. For example, a low-impact collision by a vehicle may lead to a slight tilt of a charger post, rather than a complete or partial break. A tilt or tipping of an EV charging station (or components thereof) may not be readily apparent, even upon visual inspection. More generally, a change in a physical state (e.g., level of inclination) of an EV charging station from an initial or neutral state may not be easily detected in the absence of clear and obvious indications of a break.

In order to facilitate determination of changes in physical state, a motion sensor may be deployed in the EV charging station. A motion sensor is a sensor that is configured to determine whether the EV charging station (or components thereof) undergoes movement, such as rotational or linear motion. Examples of motion sensors which may be deployed include, but are not limited to, accelerometers, tilt indicators, and gyroscopes. One or more motion sensors may be mounted directly to the EV charging station, such as a housing that contains EV charger components. In some implementations, motion sensors may be built-in to particular components of the EV charging station such that a separate motion sensor is not required to be mounted. That is, the motion sensor may be an independent component or it may be integrated into a different component of the EV charging station.

A controller associated with the EV charging station may be configured to determine, based on sensor output from the motion sensor(s), whether the EV charging station undergoes rotational or linear motion. The controller may for example, be a processor that is adapted to control operations of the EV charging station. The controller is communicably coupled to the motion sensor(s) of the EV charging station such that sensor output data may be obtained (i.e., retrieved or received) directly by the controller. Responsive to detecting motion of the EV charging station, the controller may trigger suitable actions, if any, to ensure safe operation of the EV charging station in view of the detected motion. As a particular example, the controller may be configured to detect tilting or tipping of the EV charging station based on sensor output of a motion sensor associated with the EV charging station, and cause to be executed operations for facilitating maintenance and ensuring safety of use of the EV charging station.

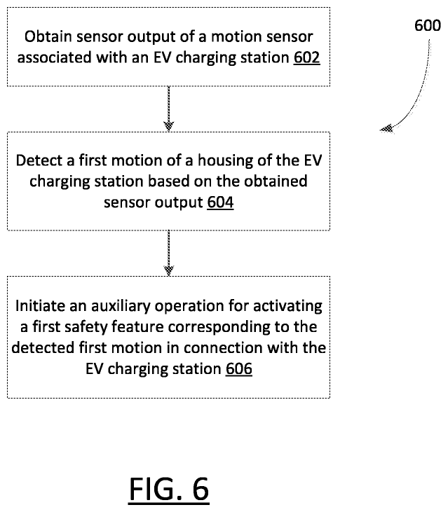

Example methods which may be performed by the controller are described in greater detail below, with reference to FIGS. 6 to 9.

Reference is made to FIG. 6, which shows, in flowchart form, an example method 600 for controlling operation of an EV charging station. Specifically, the method 600 allows for handling, in real-time, safety features for ensuring safe operation of an EV charging station in response to detecting changes in physical state of the EV charging station. For example, the operations of method 600 may be performed in initiating corrective or remedial actions intended to address potential safety hazards which may result from any detected changes in physical state. Operations 602 and onward are performed by one or more processors associated with a controller of an EV charging station. In particular, a computing system that is configured to control functionalities of the EV charging station may perform all or part of the operations of method 600.

The EV charging station may comprise a single vertical structure (FIG. 1) or a pull-up or pull-through deployment (FIGS. 3A-3B). The EV charging station includes a housing that contains at least some of the components of the EV charging station such as, for example, EV charger units. For collecting motion data associated with the EV charging station, a motion sensor may be mounted within the housing. The motion sensor may comprise, for example, one or more of an accelerometer, a tilt indicator, or a gyroscope. The motion sensor may be an independent component that is positioned in the housing, or it may be integrated into a different component of the EV charging station.

In operation 602, the controller of the EV charging station obtains sensor output of the motion sensor associated with the EV charging station. The sensor output may be retrieved by the controller or it may be transmitted to the controller via the motion sensor. In some implementations, the sensor output may be obtained by the controller periodically, at predetermined times or time intervals. That is, the motion sensor may be caused to produce output values periodically, or only those output values produced by the motion sensor at predetermined times or time intervals may be communicated to the controller.

The sensor output may comprise values of acceleration, angular velocity, and/or orientation, depending on the motion sensor that is deployed for the EV charging station. The output values are associated with a specific reference point within the EV charging station. In particular, the reference point may be the specific location of the motion sensor within the housing. In some implementations, at least a portion of the motion sensor may be disposed vertically above a threshold height of the housing. For example, the motion sensor may be mounted to the housing at or above a typical vehicle bumper height such that if only a portion of the housing above a point of impact undergoes motion (e.g., tipping), said motion would still be detectable using the motion sensor.

In at least some implementations, the motion sensor and related components may be powered separately and/or coupled to backup power (e.g., an uninterruptible power supply, or UPS) so that they can continue to operate independently of the EV charging station. For example, even in the event of a severe car crash or power outage affecting the EV charging station, a separate or backup power supply may keep the motion sensor running.

In operation 604, the controller detects a first motion of the housing based on the obtained sensor output. The controller may track values of a relevant variable indicative of motion or displacement of the housing (e.g., acceleration, angular velocity, angle formed with a horizontal/vertical plane, etc.) over time. For example, values of sensor output may be tracked by the controller and stored, in memory, beginning at a time of installation of the EV charging station, or from a most recent calibration or reset of the motion sensor. The sensor output values are used to inform a determination of whether a first motion of the EV charging station has occurred. A first motion may be detected, for example, if the controller determines that there is significant discrepancy in consecutive values of sensor output. Specifically, if there is a change in output value of the motion sensor that is considered to be significant, the controller may determine that the EV charging station (e.g., a housing of the station) has undergone a first motion. The controller may thus compare consecutive output values of the motion sensor in order to identify any discrepancies.

As part of operation 604, the controller may access threshold values for comparing any differences in sensor output values. In particular, for the relevant sensor output variable(s), the controller may obtain defined thresholds which may be used to identify any significant differences in consecutive sensor output values. If a difference in output values exceeds the relevant threshold, the controller may determine that a first motion has occurred. That is, an increase or decrease in output value of a variable that is greater than the relevant threshold may indicate occurrence of a motion or displacement of the EV charging station.

For example, a tilt indicator may output values of an angle formed with a horizontal plane. The controller may be configured to track the output of a tilt indicator associated with the EV charging station. If consecutive values of the measured angle/inclination differ by more than a defined threshold value, the controller may determine that a tilt has occurred. The detected tilt may be attributed as a tilt of at least a portion of the housing of the EV charging station. The controller may in some implementations, determine a tilt angle of the housing. That is, the controller may determine an amount of the tilt (and more generally, an amount of the detected motion).

In response to detecting that the first motion has occurred, the controller initiates an auxiliary operation for activating a first safety feature corresponding to the detected first motion in connection with the EV charging station, in operation 606. The auxiliary operation may relate to a safety feature that is designed to eliminate or reduce the risk of hazards associated with the EV charging station. In some implementations, the controller may automatically initiate the auxiliary operation responsive to detecting the first motion. Alternatively, the detection of the first motion may be just one of a plurality of preconditions for the auxiliary operation. That is, in some implementations, the controller may determine whether one or more additional defined conditions are satisfied prior to initiating the auxiliary operation.

In some implementations, the auxiliary operation may relate to control of a camera system for capturing image data. To determine the cause of a change in physical state of the EV charging station, it may be useful to analyze image data depicting an environment of the EV charging station. As part of operation 606, the controller may trigger a camera system to capture image data depicting at least a portion of an area surrounding the housing. The controller may be communicably coupled to the camera system. The camera system may for example, comprise one or more image sensors that are disposed on the housing. Such image sensors may be oriented outward from the housing to capture images/video of the surrounding area of the EV charging station. Additionally, or alternatively, the controller may be configured to trigger image capture by image sensors that are disposed externally of the housing and oriented toward an area surrounding the housing. For example, the camera system may include one or more cameras that are used for surveillance of a vicinity of the EV charging station. Such cameras may be located remotely from the housing and other components of the EV charging station.

The controller may generate control signals for requesting to obtain image data from the camera system. In at least some implementations, the controller may request to obtain image data, such as images or video, depicting the environment of the EV charging station during a defined time period preceding the time of detecting the first motion. For example, a request may be transmitted to the camera system to obtain a video clip of fixed length depicting a scene including the EV charging station and its vicinity immediately prior to the time of detecting a tilt or tipping of the housing of the EV charging station. Upon obtaining such image data, the controller may process the images/video for analysis or transmit the image data to a remote computing system, such as a computing device associated with an operator entity. In some implementations, the requested image data may comprise images and/or video depicting the surrounding environment at or after the time of detecting the first motion.

In some implementations, the auxiliary operation may relate to control of neighbouring EV charging stations. A change in physical state of an EV charging station may have an impact on any neighbouring EV charging stations. For example, a tipped or tilted housing of an EV charging station may pose the risk of falling on a nearby EV charging station or an operator thereof. As such, it may be desired to take pre-emptive action for ensuring safety of current or potential operators of neighbouring EV charging stations in a vicinity of the affected EV charging station.

In response to detecting the first motion, the controller may be configured to cause charging operations of at least one neighbouring EV charging station to be disabled. To reduce the risk of damage or injury, it may be desirable to disable, temporarily or otherwise, those EV charging stations that are immediately adjacent to the affected EV charging station. The controller may thus be configured to transmit control signals for disabling one or more of the adjacent EV charging stations responsive to detecting the first motion of the affected EV charging station. In some implementations, all or a subset of the EV charging stations that are connected to a same power supply equipment (e.g., same breaker, sub-panel, etc.) may be disabled. For example, the EV charging stations that are connected to the same power supply as the affected EV charging station may be selectively disabled by the controller.

In some implementations, the auxiliary operation may relate to display of visual information for the EV charging station. Specifically, in response to detecting the first motion, the controller may be configured to cause a visual indicator of an operational status of the EV charging station to be changed. The visual indicator may comprise various different types of visual information, such as indicator lights and graphical information presented on a display device associated with the EV charging station.

As described above, the auxiliary operation for activating the first safety feature may relate to controlling operation of an auxiliary component that is different from an EV charger unit associated with the EV charging station. In particular, the auxiliary operation may be different from safety measures relating directly to charging operations of the affected EV charging station.

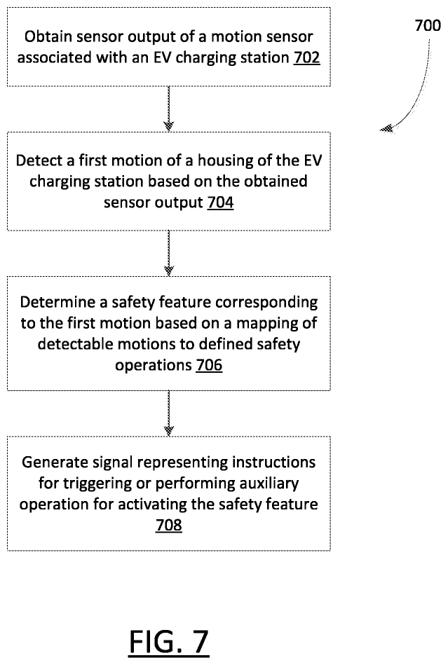

Reference is made to FIG. 7, which shows, in flowchart form, an example method 700 for controlling operation of an EV charging station. Specifically, the method 700 allows for handling, in real-time, safety features for ensuring safe operation of an EV charging station in response to detecting changes in physical state of the EV charging station. For example, the operations of method 700 may be performed in initiating corrective or remedial actions intended to address potential safety hazards which may result from any detected changes in physical state. Operations 702 and onward are performed by one or more processors associated with a controller of an EV charging station. In particular, a computing system that is configured to control functionalities of the EV charging station may perform all or part of the operations of method 700. The operations of method 700 may be performed in addition to, or as alternatives of, one or more of the operations of method 600.

In operation 702, a controller of an EV charging station obtains sensor output of a motion sensor associated with the EV charging station. The motion sensor may for example, be mounted to a housing of the EV charging station and include one or more of: an accelerometer, a gyroscope, or a tilt indicator. The controller detects a first motion of a housing of the EV charging station based on the obtained sensor output, in operation 704. The detected first motion may comprise a rotational motion (e.g., a tilt of the housing), a linear motion, and the like. Operations 702 and 704 may be performed in a similar manner as operations 602 and 604, respectively, of method 600.

In operation 706, the controller identifies a safety feature corresponding to the first motion based on a mapping of changes in physical state (e.g., detected motion) of the EV charging station to one or more defined safety operations. The mapping may for example, comprise a set of instructions identifying one or more physical states and changes thereof (e.g., rotational or linear motion, displacement, etc.) and corresponding operations that are suitable for executing in connection with the EV charging station. That is, the mapping may indicate operations that are suitable to be executed by the controller in different detected scenarios of changes in physical state of the EV charging station. The mapping may be stored, for example, in memory that is accessible to the controller.

For example, the mapping may include a list of different types of motion and, for each type, an indication of safety operations which may be automatically initiated by the controller in response to detecting said type. In some implementations, the mapping may indicate values or range of values of motion sensor output, such as orientation, acceleration, etc., and identify the actions which may or should be performed for those values/range. The output values of the motion sensor represent the amount of detected tilt, movement, etc. associated with the EV charging station. Depending on the motion sensor output values, the controller may identify a corresponding action for executing. The identified actions relate to a safety feature for addressing potential hazards associated with the detected motion, i.e., motion associated with the detected sensor output values.

In operation 708, the controller generates signals representing instructions for triggering or performing auxiliary operation for activating the identified safety feature. In particular, the auxiliary operation may comprise actions that are suitable for resolving a safety hazard in accordance with the defined mapping of detectable motions to safety operations. The auxiliary operation may include any one or more of the auxiliary operations described above with reference to method 600 of FIG. 6. The signals may then be selectively transmitted to different control elements associated with the affected EV charging station, one or more neighbouring EV charging stations, and/or power supply equipment for the EV charging stations.

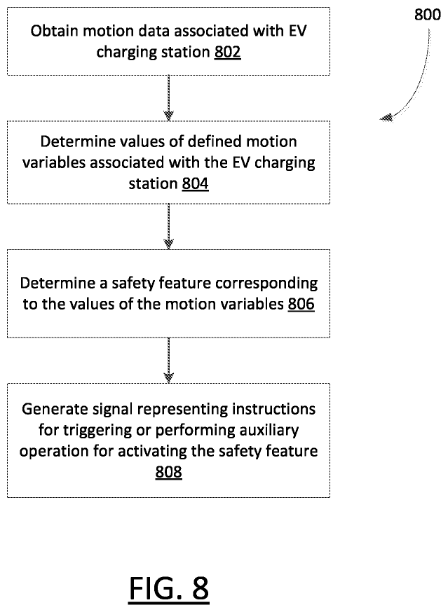

Reference is made to FIG. 8, which shows, in flowchart form, an example method 800 for controlling operation of an EV charging station. Specifically, the method 800 allows for handling, in real-time, safety features for ensuring safe operation of an EV charging station in response to detecting changes in physical state of the EV charging station. For example, the operations of method 800 may be performed in initiating corrective or remedial actions intended to address potential safety hazards which may result from any detected changes in physical state. Operations 802 and onward are performed by one or more processors associated with a controller of an EV charging station. In particular, a computing system that is configured to control functionalities of the EV charging station may perform all or part of the operations of method 800. The operations of method 800 may be performed in addition to, or as alternatives of, one or more of the operations of methods 600 and 700.

A controller associated with an EV charging station obtains motion data associated with the EV charging station, in operation 802. The motion data may comprise, for example, sensor output values from a motion sensor of the EV charging station. The motion sensor may include one or more of: an accelerometer, a gyroscope, or a tilt indicator, and may be mounted in a housing associated with the EV charging station. Operation 802 may be performed in a similar manner as operations 602 and 702 of methods 600 and 700, respectively.

In some implementations, the motion data associated with the EV charging station may include data from sensors that are different from motion sensors. By way of example, the motion data may comprise image data from one or more cameras that depict movement of a housing of the EV charging station. Such image data may include, for example, images of the housing which are captured using the cameras at different times. Additionally, or alternatively, the image data may include images from cameras that are disposed on the housing and that are oriented to capture images of an area surrounding the housing. The image data may be analyzed (e.g., by the controller) to determine whether the housing has moved (e.g., tilted, tipped, etc.). Specifically, images that are captured by the same camera(s) at different times may be compared with each other to identify any changes in the images that are indicative of movement of the housing.

In operation 804, the controller determines values of motion variables associated with the EV charging station. The motion variables refer to predefined variables describing motion, such as rotational or linear motion, of the EV charging station. The motion variables may include standard motion variables including, for example, angular velocity, acceleration, and displacement. The controller may additionally determine values of other motion variables that can be derived from the standard motion variable values, such as direction of motion, time or duration of motion, and the like. These values may be determined upon processing sensor output values of a motion sensor (and any other motion data) associated with the EV charging station that is obtained by the controller.

Upon detecting motion of the EV charging station and determining the values of the motion variables, the controller determines a suitable safety feature to activate, in operation 806. In particular, the controller is configured to identify a safety feature that corresponds to the detected motion as indicated, at least in part, by the values of the motion variables. In some implementations, the controller may access a defined mapping which maps motion variable values to safety features for the EV charging station. The mapping may indicate, for each safety feature, specific actions that are associated with the safety feature and which are required or recommended to be executed to activate the safety feature.

As an illustrative example, the controller may be configured to detect a tilt or tipping of an EV charging station based on motion data obtained by the controller. From the motion data, the controller may determine certain motion variable values, such as a direction and/or an amount of the tilt. The controller may proceed to activate a safety feature that depends on, or corresponds to, the direction and amount of the tilt. For example, if the controller determines that a housing of the EV charging station is tilted or falling in a particular direction, the controller may determine a potential “fall zone”, i.e., an area on which the housing may fall. In a pull-through deployment, a fall zone may include at least a portion of a lane that the affected EV charging station may fall on to. A fall zone may include one or more neighbouring EV charging stations. Such neighbouring EV charging stations may be identified, for example, based on system architecture data associated with the EV charging stations. In response to identifying the neighbouring EV charging stations within or in a vicinity of the fall zone, the controller may cause power to one or more of said EV charging stations to be cut, either temporarily or permanently. That is, the EV charging stations of the fall zone may be disabled. Additionally or alternatively, in some implementations, another action may be taken at an EV charging station that is determined to be in a fall zone or near a fall zone. For example, lighting or another indicator may be toggled to indicate that the EV charging station is out of service and/or an audible alert may be toggled to indicate that a vehicle that is charging at that EV charging station should not be moved until it is safe to do so and/or a cable management system may be locked to prevent any extension of a charging cable associated with that EV charging station. Accordingly, in at least some implementations, a fall direction of an EV charging station may be used to determine an auxiliary operation that is to be performed and/or to select an EV charging station that is to perform or be affected by the auxiliary operation.

As another illustrative example, the controller may detect a tilt of an EV charging station and determine an amount of the tilt (e.g., an angle of declination) based on motion sensor output data. Depending on the amount of the tilt, different safety features may be activated by the controller. In particular, the controller may initiate different auxiliary operations (for activating suitable safety features) that correspond to the amount of tilt of the EV charging station. For example, if the detected tilt is less than a defined threshold amount, a first set of auxiliary operations (e.g., triggering an indicator light or alarm, capturing image data using a camera system, etc.) may be initiated by the controller. If, on the other hand, the tilt is equal to or exceeds the defined threshold amount, a second different set of auxiliary operations may be executed (e.g., disconnect power to the EV charging station and/or neighbouring EV charging stations). For example, if the detected tilt increases from an initial amount to or beyond the defined threshold amount, the controller may initially execute the first set of auxiliary operations and then proceed to execute the second of auxiliary operations.

In operation 808, the controller generates signals representing instructions for triggering or performing auxiliary operation for activating the safety feature. The auxiliary operation may be indicated, for example, by the mapping of motion variable values to safety features and may include any one or more of the auxiliary operations described above with reference to method 600 of FIG. 6. The signals may then be selectively transmitted to different control elements associated with the affected EV charging station, one or more neighbouring EV charging stations, and/or power supply equipment for the EV charging stations

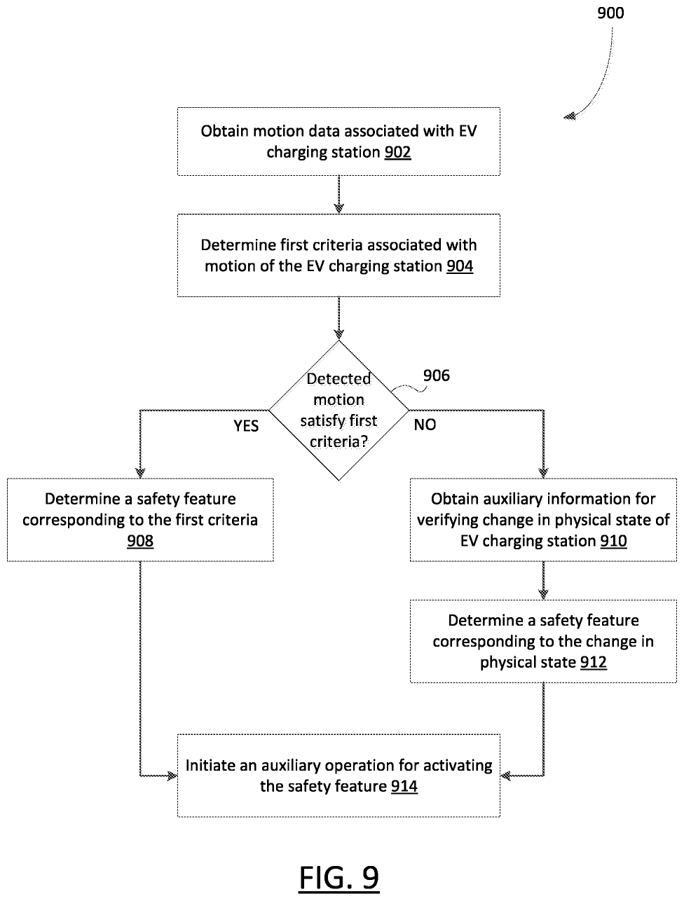

Reference is made to FIG. 9, which shows, in flowchart form, an example method 900 for controlling operation of an EV charging station. Specifically, the method 900 allows for handling, in real-time, safety features for ensuring safe operation of an EV charging station in response to detecting changes in physical state of the EV charging station. For example, the operations of method 900 may be performed in initiating corrective or remedial actions intended to address potential safety hazards which may result from any detected changes in physical state. Operations 902 and onward are performed by one or more processors associated with a controller of an EV charging station. In particular, a computing system that is configured to control functionalities of the EV charging station may perform all or part of the operations of method 900. The operations of method 900 may be performed in addition to, or as alternatives of, one or more of the operations of methods 600, 700, and 800.

In operation 902, a controller associated with an EV charging station obtains motion data associated with the EV charging station. The motion data may comprise, for example, sensor output values from a motion sensor of the EV charging station. The motion sensor may include one or more of: an accelerometer, a gyroscope, or a tilt indicator, and may be mounted in a housing associated with the EV charging station. Operation 902 may be performed in a similar manner as operations 602 and 702 of methods 600 and 700, respectively.

In operation 904, the controller determines first criteria associated with motion of the EV charging station. In some implementations, the first criteria may relate to values of motion variables as determined based on the obtained motion data. As an example, the first criteria may include a duration of the detected motion, such as rotational motion leading to a tilt. The first criteria may indicate a threshold length of time representing a duration that is indicative of sustained motion as opposed to temporary motion (e.g., shaking or vibration). As another example, the first criteria may include an amount of the detected motion, such as a tilt, of the EV charging station. The first criteria may indicate a threshold amount of tilt representing a statistically significant tilt (and not a negligible motion).

The controller then determines whether the detected motion satisfies the first criteria, in operation 906. In particular, the controller may compare values of the motion variables as obtained via the motion data and thresholds that are defined by the first criteria. If the detected motion satisfies the first criteria, the controller identifies a safety feature corresponding to the first criteria, in operation 908. For example, if a duration or amount of the detected motion exceeds a corresponding threshold value, the controller may determine that the first criteria are satisfied and identify one or more suitable safety features, i.e., auxiliary operations for addressing potential hazards associated with the detected motion.

If, on the other hand, the detected motion does not satisfy the first criteria, the controller obtains auxiliary information for verifying change in a physical state of the EV charging station, in operation 910. For example, the controller may attempt to obtain sensor data of one or more sensors associated with the EV charging station to determine whether a motion (e.g., a tilt) of the EV charging station has actually occurred. Upon verifying that there has indeed been a change in the physical state of the EV charging station, the controller then identifies a safety feature corresponding to the change in the physical state, in operation 912. In operation 914, the controller initiates one or more auxiliary operations for activating the safety feature.

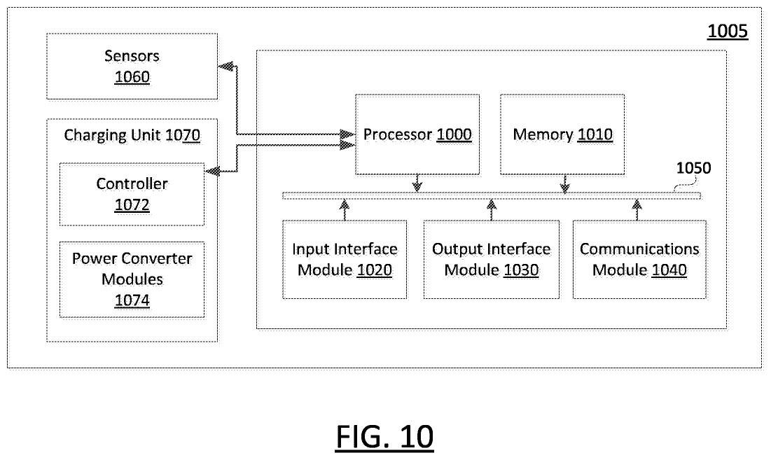

Reference is made to FIG. 10, which is a high-level operation diagram of an example EV charging station 1005. The example EV charging station 1005 includes a variety of modules. For example, as illustrated, the example EV charging station 1005, may include a processor 1000, a memory 1010, an input interface module 1020, an output interface module 1030, and a communications module 1040. As illustrated, the foregoing example modules of the example EV charging station 1005 are in communication over a bus 1050.

The processor 1000 is a hardware processor. The processor 1000 may, for example, be one or more ARM, Intel x86, PowerPC processors or the like.

The memory 1010 allows data to be stored and retrieved. The memory 1010 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example EV charging station 1005.

The input interface module 1020 allows the example EV charging station 1005 to receive input signals. Input signals may for example, correspond to input received from a user. The input interface module 1020 may serve to interconnect the example EV charging station 1005 with one or more input devices. Input signals may be received from input devices by the input interface module 1020. Input devices may for example, include one or more of a touchscreen input, keyboard, trackball or the like. In some implementations, all or a portion of the input interface module 1020 may be integrated with an input device. For example, the input interface module 1020 may be integrated with one of the aforementioned example input devices.

The output interface module 1030 allows the example EV charging station 1005 to provide output signals. Some output signals may for example allow provision of output to a user. The output interface module 1030 may serve to interconnect the example EV charging station 1005 with one or more output devices. Output signals may be sent to output devices by output interface module 1030. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 1030 may be integrated with an output device. For example, the output interface module 1030 may be integrated with one of the aforementioned example output devices.

The communications module 1040 allows the example EV charging station 1005 to communicate with other electronic devices and/or various communications networks. For example, the communications module 1040 may allow the example EV charging station 1005 to send or receive communications signals. Communications signals may be sent or received according to one or more protocols or according to one or more standards. For example, the communications module 1040 may allow the example EV charging station 1005 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 1040 may allow the example EV charging station 1005 to communicate using near-field communication (NFC), via Wi-Fi™, using Bluetooth™ or via some combination of one or more networks or protocols. Contactless payments may be made using NFC. In some implementations, all or a portion of the communications module 1040 may be integrated into a component of the example EV charging station 1005. For example, the communications module may be integrated into a communications chipset.

Software comprising instructions is executed by the processor 1000 from a computer-readable medium. For example, software may be loaded into random-access memory from persistent storage of memory 1010. Additionally, or alternatively, instructions may be executed by the processor 1000 directly from read-only memory of memory 1010.

The EV charging station 1005 may also include a plurality of sensors 1060 such as, without limitation, accelerometers, gyroscopes, tilt indicators, cameras, etc. In at least some implementations, one or more of the sensors 1060 may be contained in a housing associated with the EV charging station 1005. In particular, at least one sensor 1060 that is configured to measure motion (e.g., acceleration, angular velocity, etc.) of a structure may be housed within the EV charging station 1005. One or more charging units 1070 may be included in the EV charging station 1005. The charging units 1070 may, in some implementations, be controlled by a controller 1072 which may be different from the processor 1000. The charging units 1070 may each include at least one power converter module 1074, such as an AC-to-DC converter.

The various implementations presented above are merely examples and are in no way meant to limit the scope of this application. Variations of the innovations described herein will be apparent to persons of ordinary skill in the art, such variations being within the intended scope of the present application. In particular, features from one or more of the above-described example implementations may be selected to create alternative example implementations including a sub-combination of features which may not be explicitly described above. In addition, features from one or more of the above-described example implementations may be selected and combined to create alternative example implementations including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. An electric vehicle charging station, comprising:
a housing;
a motion sensor mounted within the housing;
a processor communicably coupled to the motion sensor, the processor being configured to:
obtain sensor output of the motion sensor;
detect a first motion of the housing based on the obtained sensor output; and
in response to detecting the first motion, initiate an auxiliary operation for activating a first safety feature corresponding to the detected first motion in connection with the electric vehicle charging station.

2. The electric vehicle charging station of claim 1, wherein the housing comprises a bollard assembly.

3. The electric vehicle charging station of claim 1, wherein the motion sensor comprises at least one of: an accelerometer; a gyroscope; or a tilt indicator.

4. The electric vehicle charging station of claim 1, wherein detecting the first motion of the housing comprises determining that a tilt of at least a portion of the housing has occurred.

5. The electric vehicle charging station of claim 1, further comprising an electric vehicle charger unit including at least one power converter module, wherein initiating the auxiliary operation for activating a first safety feature comprises controlling operation of an auxiliary component that is different from the electric vehicle charger unit.

6. The electric vehicle charging station of claim 1, wherein initiating the auxiliary operation for activating a first safety feature comprises triggering a camera system to capture image data depicting at least a portion of an area surrounding the housing.

7. The electric vehicle charging station of claim 6, wherein the camera system comprises one or more image sensors that are disposed on the housing.

8. The electric vehicle charging station of claim 6, wherein the camera system comprises one or more image sensors that are disposed externally of the housing and oriented toward an area surrounding the housing.

9. The electric vehicle charging station of claim 1, wherein initiating the auxiliary operation for activating a first safety feature comprises causing charging operations of at least one neighbouring electric vehicle charging station to be disabled.

10. The electric vehicle charging station of claim 1, wherein at least a portion of the motion sensor is disposed vertically above a threshold height of the housing.

11. The electric vehicle charging station of claim 10, wherein the processor is further configured to determine that at least a portion of the housing that is vertically above the threshold height undergoes the first motion.

12. The electric vehicle charging station of claim 1, wherein the processor is further configured to identify the first safety feature based on a mapping between one or more detectable motions of the housing and one or more defined safety operations associated with the electric vehicle charging station.

13. The electric vehicle charging station of claim 1, wherein detecting the first motion of the housing comprises determining a tilt angle of the housing.

14. The electric vehicle charging station of claim 1, wherein initiating the auxiliary operation for activating a first safety feature comprises causing a visual indicator of an operational status of the electric vehicle charging station to be changed.

15. A processor-implemented method, comprising:
obtaining sensor output of a motion sensor mounted within a housing of an electric vehicle charging station;
detecting a first motion of the housing based on the obtained sensor output; and
in response to detecting the first motion, initiating an auxiliary operation for activating a defined safety feature corresponding to the detected first motion in connection with the electric vehicle charging station.

16. The method of claim 15, wherein the motion sensor comprises at least one of: an accelerometer; a gyroscope; or a tilt indicator.

17. The method of claim 15, wherein initiating the auxiliary operation for activating a first safety feature comprises triggering a camera system to capture image data depicting at least a portion of an area surrounding the housing.

18. The method of claim 15, wherein initiating the auxiliary operation for activating a first safety feature comprises causing charging operations of at least one neighbouring electric vehicle charging station to be disabled.

19. The method of claim 15, wherein initiating the auxiliary operation for activating a first safety feature comprises causing a visual indicator of an operational status of the electric vehicle charging station to be changed.

20. A non-transitory, computer-readable storage medium storing computer-executable instructions that, when executed by a processor, are to cause the processor to:
obtain sensor output of a motion sensor;
detect a first motion of a housing of an electric vehicle charging station based on the obtained sensor output; and
in response to detecting the first motion, initiate an auxiliary operation for activating a defined safety feature corresponding to the detected first motion in connection with the electric vehicle charging station.
